(19) United States
(12) Patent Application Publication
(10) Pub. No.: US 2012/0247401 A1
(43) Pub. Date: Oct. 4, 2012

(54) Pet Walk, Pet Tunes

(76) Inventor: Roman Nolet, La Habra, CA (US)

(21) Appl. No.: 13/433,782

(22) Filed: Mar. 29, 2012

Related U.S. Application Data
(60) Provisional application No. 61/468,890, filed on Mar. 29, 2011.

(51) Int. Cl. A01K 27/00; A01K 29/00

(52) U.S. Cl. 119/859

(57) ABSTRACT

The invention provides a pet music system for providing music and sound effects to pets for influencing, modifying and controlling their mood and behavior. The pet music system of the present invention comprises a portable, lightweight music player, such as an MP3 player, for example, removably attached to the collar of a pet or the halter of a large animal. The music player also incorporates at least one speaker, and a plurality of control buttons for selectively playing a song or sound effect. A pet tunes CD is pre-recorded with a variety of recordings and is transferable to the music player

### CLAIM OF PRIORITY

This patent application claims priority under 35 USC 119 (e) (1) from U.S. Provisional Patent Application Ser. No. 61/468,890 filed Mar. 29, 2011, of common inventorship herewith entitled, “Pet Pod, Pet Walk, Pet Tunes.”

### FIELD OF THE INVENTION

The present invention relates to the field of pet accessories, and more specifically to the field of a pet music system having a compact and programmable speaker and MP3 player mounted to a collar of a pet for providing music and sound effects, for calming, relaxing or exciting and motivating a pet.

### BACKGROUND OF THE INVENTION

Humans have long known that properly chosen sound and music relax or arouse us, help us to sleep or motivate us to action. With a portable music player such as an MP3 player, along with a set of earphones or earbuds, we can privately enjoy a library of music while engaging in other activities such as riding a bike, jogging, travelling on a plane or subway, enjoying a walk on the beach or walking our dog in the park. It is natural that pet owners have witnessed the influence that sound has on the behavior of pets.

The present invention provides a device which incorporates the effects of music and sound to pets by providing pets with a unique and exciting system which offers a variety of tunes and sound effects designed for the enjoyment and well-being of the pet. The present invention is suitable for animal owners, groomers, kennels, trainers, veterinarians, pet adoption agencies, pet stores and other situations involving animals, both domestic and international. It can be useful in situations involving any pet or animal handled by humans, including, but not limited to dogs, cats, or horses, for example. The present invention is suitable for distribution through variety stores, discount drugstores, pet supply retailers, pet shops, horse furnishings and tack stores mail order catalog shopping, internet sites, television commercials, infomercials and exporters.

### DESCRIPTION OF THE PRIOR ART

The prior art has put forth several devices for calming animals. Among these are:

U.S. Pat. No. 6,170,439 to Duncan describes a remote controlled animal training system.

U.S. Pat. No. 6,598,563 to Kim describes a pet training device.

U.S. Pat. No. 7,246,033 to Kudo describes a pedometer for pets.

U.S. Pat. No. 7,552,699 to Moore discloses an animal behavior modification system.

None of these references describe the present invention.

While these devices fulfill their respective, particular objective requirements, the aforementioned patents do not describe a pet music system providing music and other sound effects designed to calm and sooth a pet or to excite and motivate them. Therefore, they would not be as suitable for the purpose of the present invention as disclosed hereafter.

### SUMMARY OF THE INVENTION

It is an object of the present invention to provide a pet music system for influencing, modifying and controlling a pet's mood and behavior.

It is a further object of the present invention to provide a pet music system which easily mounts to the collar of a dog or cat, or to a halter for a horse, or other large animal.

It is a still further object of the present invention to provide a pet music system that provides soothing comfort to a pet while the owner is away.

It is a still further object of the present invention to provide a pet music system wherein the pet and pet owner can listen to music simultaneously.

It is a still further object of the present invention to provide a pet music system operable by remote control.

The present invention provides a pet music system for providing music and sound effects to pets for influencing, modifying and controlling their mood and behavior. The pet music system of the present invention comprises a portable, lightweight music player, such as an MP3 player, for example, removably attached to the collar of a pet or the halter of a large animal. The music player also incorporates at least one speaker, and a plurality of control buttons for selectively playing a song or sound effect. A pet tunes CD is pre-recorded with a variety of recordings and is transferable to the music player. The music player is in wireless communication with a master remote control. The master remote control has a plurality of buttons for controlling and selecting playing a song or sound selection and for controlling the volume.

To the accomplishment of the above and related objects the invention may be embodied in the form illustrated in the accompanying drawings. The accompanying drawings are illustrative only, and other obvious variations and embodiments are contemplated as being part of the invention, limited only by the scope of the claims.

### BRIEF DESCRIPTION OF THE DRAWINGS

In the drawings; like elements are depicted by like reference numerals. The drawings are briefly described as follows.

FIG. 1 is a diagrammatic perspective view of the pet music system of the present invention having an MP3 player removably attached to the collar of a pet or the halter of a large animal, a pet tunes CD, or digital music library, portable ear phones and a master remote control.

### DETAILED DESCRIPTION OF THE PREFERRED EMBODIMENT

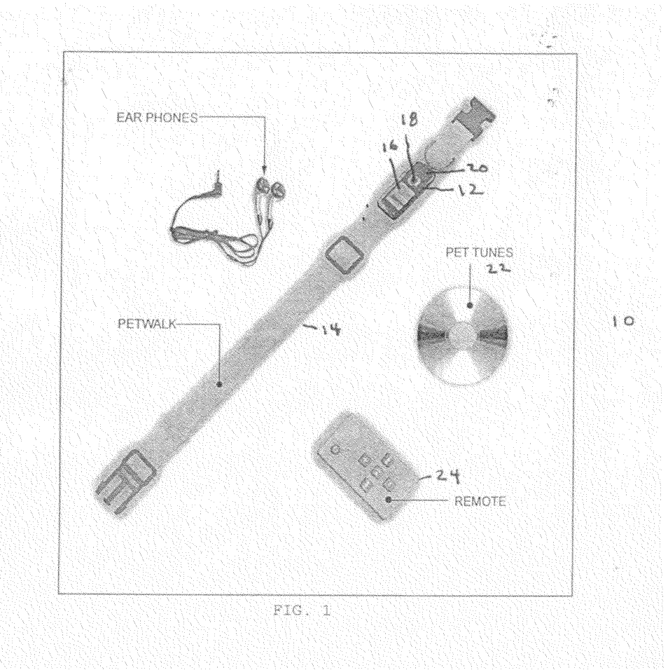

FIG. 1 illustrates components of the pet music system 10 of the present invention. The pet music system 10 allows pets to listen to music and various other sound effects for calming and soothing or exciting and motivating them. In its broadest context, the pet music system 10 has a music player 12 removably mounted to a collar 14 for influencing, modifying and controlling a pet's mood or behavior.

As humans have long been aware, music and sounds easily alter our mood and behavior. Easy listening melodies and sounds of the ocean may calm our nerves while faster beats may motivate us to action. The pet music system 10 of the present invention allows pet owners a unique and effective means of influencing and controlling their pet's mood and behavior either immediately as needed, or when the pet is alone.

The pet music system 10 utilizes a music player 12 to disseminate selected music or sounds to the listening pet. The music player 12 is similar to a portable, lightweight programmable MP3 player as known in the art. The music player 12 receives power from rechargeable batteries. In the preferred embodiment, the music player 12 has a front surface 16 with a plurality of buttons 18 to selectively choose the desired music or sound effect. In an alternative embodiment, the music player 12 is in wireless communication with a master remote control 24 for selectively choosing the music or sound effect. Preferably the music player 12 also includes a speaker 20 on the from surface 16, thereby allowing the pet owner to simultaneously listen to the selected music along with their pet. This allows pet owners a better means for assessing how each song or sound effect affects their pet's mood and behavior.

In another preferred embodiment, a pet tunes CD 22 is included within the pet music system 10. The pet tunes CD 22 includes different recordings that are pleasurable to different pets and suitable for use at home, in the office, traveling in the car, or with a portable CD player. The recordings on the pet tunes CD 22 vary from soothing, easy-listening melodies to eh sounds of rushing streams and other natural scenes and even sounds of other animals. The music and sounds on the pet tunes CD 22 is transferrable to the music player. A variety of different music genres and sounds are contemplated.

Preferably, the music player 12 of the pet music system 10 removably mounts to a collar 14 of a pet that is preferably suitable for a dog or cat. In alternative embodiments, the music player is mounted to the halter of a large animal such as a horse. Other animal devices are contemplated for use coupling with the present system. In the preferred embodiment, the collar 14 is made from a leather or nylon strap such that the collar 14 is snug and comfortable around the pet's neck. The music player 12 removably couples or mounts to the collar 14 via clips, snaps or other fastening means such that the music player 12 is removable and replaceable on the collar 14 with new music and sound effects as the pet owner desires.

The master remote control 24 if the pet music system 10 wirelessly communicates with the music player 12. The master remote control 24 is similar to known portable remote controls in the art. The master remote control 24 receives power from rechargeable batteries. The master remote control 24 has a plurality of buttons 28 for allowing the pet owner to selectively play a specific song or sound selection and control the volume of the music player 12. In an alternative embodiment, the master remote control 24 has an ear phone jack (not shown) for receiving a pair of earphones or earbuds 26 therein. The ear phones 26 allow the pet owner to listen to the song or sound at the same time the pet is listening.

The pet music system 10 of the present invention is suitable for use while out for a walk or ride, while playing, or when the pet is alone at home. Alternative embodiments are contemplated wherein the pet music system 10 is used in conjunction with a web based platform such that pet owners download additional tunes and sounds for their pets through the world wide web.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A pet music system device comprising a music player removably mounted to a collar for influencing, modifying and controlling a pet's mood or behavior.

2. The pet music system device of claim 1 wherein the music player a portable, lightweight programmable MP3, wherein the player receives power from rechargeable batteries.

3. The pet music system device of claim 1 wherein the music player has a front surface with a plurality of buttons to selectively choose the desired music or sound effect.

4. The pet music system device of claim 1 wherein the music player is in wireless communication with a master remote control for selectively choosing the music or sound effect.

5. The pet music system device of claim 3 wherein the music player also includes a speaker on the front surface, thereby allowing the pet owner to simultaneously listen to the selected music.

6. The pet music system device of claim 1 wherein a pet tunes CD is included within the pet music system.

7. The pet music system device of claim 1 wherein the music and sounds on the pet tunes CD is transferrable to the music player.

8. The pet music system device of claim 1 wherein the music player of the pet music system is removably mounted to a collar.

9. The pet music system device of claim 1 wherein the music player of the pet music system is removably mounted to a halter of a large animal such as a horse.

10. The pet music system device of claim 1 wherein the collar is made from a leather or nylon strap such that the collar is snug and comfortable around the pet's neck.

11. The pet music system device of claim 1 wherein the music player removably couples or mounts to the collar via clips, snaps or other fastening means such that the music player is removable and replaceable on the collar.

12. The pet music system device of claim 1 further comprising a master remote control in wireless communication with the music player.

13. The pet music system device of claim 12 wherein the master remote control receives power from rechargeable batteries.

14. The pet music system device of claim 12 wherein the master remote control has a plurality of buttons for allowing the pet owner to selectively play a specific song or sound selection and control the volume of the music player.

15. The pet music system device of claim 12 wherein the master remote control has an ear phone jack for receiving a pair of earphones or earbuds therein.
